(19) United States
(12) Patent Application Publication
(10) Pub. No.: US 2026/0221034 A1
(43) Pub. Date: Jul. 30, 2026

(54) AUTOMATED PARKING TOOL

(71) Applicant: YELLOW LINE PARKING LTD, London (GB)

(72) Inventor: John Fogelin, London (GB)

(21) Appl. No.: 19/141,489

(22) PCT Filed: Dec. 20, 2023
(86) PCT No.: PCT/EP2023/087130

§ 371 Date: Jun. 20, 2025

(30) Foreign Application Priority Data
Dec. 22, 2022 (GB) 2219579.6

(51) Int. Cl. G08G 1/14; G06N 20/00

(52) U.S. Cl. CPC G08G 1/144; G06N 20/00

(57) ABSTRACT

The invention relates to an arrangement for predicting the availability of parking spaces using data derived at least partly from users. There is provided a computer-implemented method of identifying an available parking space, comprising: detecting that a parking space has been occupied by a first user; updating an occupancy database that the parking space has been occupied; performing a first prediction regarding when the parking space will become available from the first user; receiving an indication that a second user is seeking a parking space; performing a second prediction regarding when the second user will arrive at the parking space; and dependent on the first prediction and the second prediction, directing the second user to the parking space.

### BACKGROUND

Finding a space to park in a congested area, such as a city, can be very difficult. Once local to the destination, a driver can spend a significant amount of time circling a particular area looking for spaces to park, wasting time and fuel, as well as adding to congestion on the roads.

Conventional means of detecting and indicating that a parking space is free can require significant investments in hardware, for example buried electromagnetic plates to detect the presence of a vehicle. These systems can be costly to install and require regular maintenance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The invention relates to an arrangement for predicting the availability of parking spaces using data derived at least partly from users. The computer-implemented method provided comprises detecting that a parking space has been occupied by a first user. An occupancy database is then updated to state that the particular parking space has been occupied. A first prediction is then performed, to predict when the parking space will become available again. In the meantime, an indication is received that a second user is seeking a parking space. A second prediction is then performed regarding when the second user will arrive at the parking space in question. If the parking space is likely to be free by the time the second user arrives, according to a predefined certainty metric, then the second user is directed to the parking space.

A first aspect provides a computer-implemented method of identifying an available parking space, comprising: detecting that a parking space has been occupied by a first user; updating an occupancy database that the parking space has been occupied; performing a first prediction regarding when the parking space will become available from the first user; receiving an indication that a second user is seeking a parking space; performing a second prediction regarding when the second user will arrive at the parking space; and dependent on the first prediction and the second prediction, directing the second user to the parking space.

A further aspect provides a system for identifying an available parking space, comprising: a central server, operable to: detect that a parking space has been occupied by a first user via a first mobile device; update an occupancy database that the parking space has been occupied; perform a first prediction regarding when the parking space will become available from the first user; receive an indication that a second user is seeking a parking space from a second mobile device; perform a second prediction regarding when the second user will arrive at the parking space; and dependent on the first prediction and the second prediction, direct the second user to the parking space.

A further aspect provides a computer program product stored in a (non-transitory) computer storage medium and comprises machine-executable instructions which, when executed on a device, cause the device to perform acts comprising: detecting that a parking space has been occupied by a first user; updating an occupancy database that the parking space has been occupied; performing a first prediction regarding when the parking space will become available from the first user; receiving an indication that a second user is seeking a parking space; performing a second prediction regarding when the second user will arrive at the parking space; and dependent on the first prediction and the second prediction, directing the second user to the parking space.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc., and do not include propagated signals. The software may be suitable for execution on a parallel processor or a serial processor such that the method steps may be carried out in any suitable order, or simultaneously.

This acknowledges that firmware and software may be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows a flow diagram of a first example method of detecting and coordinating parking space availability;

FIGS. 2 and 3 show a flow diagram of a second and third example method of detecting and coordinating parking space availability;

FIG. 4 shows a plan view of the parking arrangement in use; and

FIG. 5 shows a representation of the links between different computer entities.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Described herein is a computer-implemented method of detecting and coordinating parking space availability using a central server, thereby fuel consumption for vehicles (because vehicle running time is reduced) and, as a consequence, environmental pollution. The arrangement does not require installation of road-side hardware (e.g. buried sensors or cameras) and so is easily and quickly deployable in towns and cities. There is provided a central server wirelessly connected to a first mobile device belonging to a first user, and a second mobile device belonging to a second user.

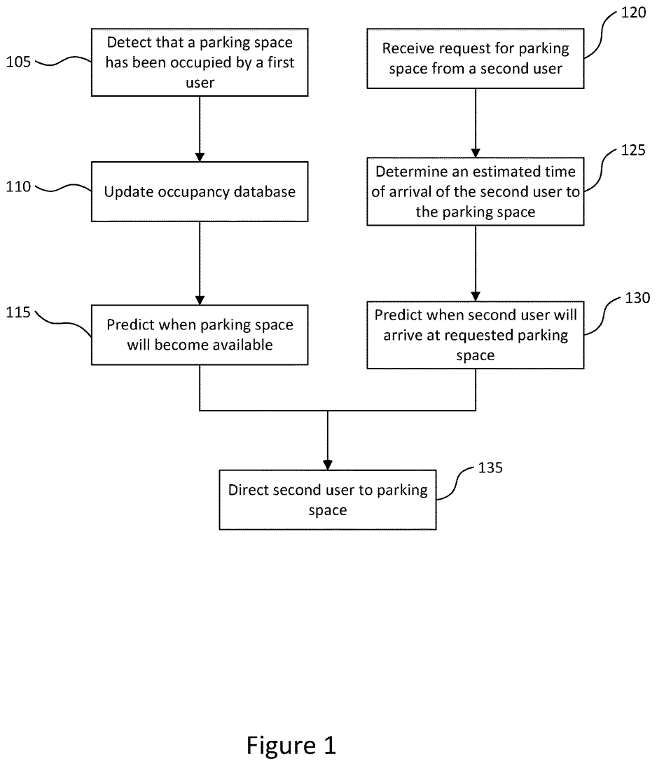

FIG. 1 is a flow diagram of a first example method of detecting and coordinating parking space availability. In step 105, data is transmitted in the form of a notification from the first mobile device to the central server, which registers, in response to receiving the notification, that a parking space has been occupied by a first user. The data received by the central server comprises location data regarding the position of the vehicle and hence the parking space which has been occupied. The transmission of the notification is triggered by a detection means local to the first mobile device, arranged to detect that a parking space has been occupied.

In one example, the first mobile device is equipped with a geolocation module (e.g. a GPS module). If the geolocation module detects that the first mobile device has remained stationary for the predetermined period of time, relevant data is transmitted via the first mobile device to the central server, which registers that a parking space has been occupied. In one example, the predetermined period of time is five minutes

Further data may be transmitted to the central server from the first mobile device, for example regarding the speed of movement of the first mobile device following the stationary period. The first mobile device of this example, optionally through the use of a geolocation module and/or gyroscopic sensors, transmits data to the central server that it is travelling at a predetermined speed classified by the central server as “driving”, followed by a predetermined stationary period classified by the central server as “parking”, followed by a predetermined speed classified by the central server as “walking”. In such a case, the central server analyses the received data and detects that the first user has, within a predetermined level of certainty, driven to a parking space and then walked away, hence leaving their vehicle in that parking space and rendering the parking space no longer vacant.

Alternative or additional detection means may be provided local to the first mobile device, such as a Bluetooth module, WiFi module, or other wireless connection module. The first mobile device may also be provided with one or more modules allowing it to perform one or more of: geolocation, Bluetooth connectivity, detection of movement, detection of acceleration, an internet connection, analysis of social media posts, and/or a timing mechanism.

In one example, the first mobile device registers a wireless connection status between the wireless connection module and a vehicle driven by the first user. In this example, if the wireless connection between the first mobile device and the vehicle registers as “connected” on the first mobile device for a predetermined period of time, and then registers as “disconnected”, this triggers the first mobile device to transmit a notification to the central server regarding the change in connection status.

Such a disconnection may be the result of the first mobile device moving out of range of their vehicle, for example if the first user left their vehicle parked while they walked away with their first mobile device. Alternatively or additionally, the disconnection may be result of a wireless connection module of their vehicle becoming automatically deactivated when the vehicle is turned off. In any of these examples, the central server may then record that a parking space has been occupied, given that the data received by the central server from the mobile device indicates that the first mobile device is no longer local to the vehicle, and/or the vehicle has been turned off.

Once the central server has received the notification from the first mobile device that a parking space has been occupied, an occupancy database stored in the central server is updated in step 110. The occupancy database may identify all of the available spaces within a specific zone, details of payment, and/or time restrictions for users seeking to park within that zone.

Having received the notification from the first mobile device that a parking space has been occupied, a prediction is made in step 115 by the central server as to when the parking space will become vacant or is vacant. The prediction may comprise a weighted estimation of one or more factors, for example: duration of parking; analysis of the behaviour of the past individual (such as regular trips to a coffee shop, or other routine visits); analysis of motion of a mobile device; vector of travel (for example in the direction of car on a local road); sensor pairing information, and/or geolocation. A weighted average of a plurality of factors may be used to yield a confidence level. Above a predetermined confidence level, for example a confidence level of 90%, the space may be deemed “likely available”.

The central server uses data acquired from the first mobile device as an input, and processes said data to form the prediction of step 115. In one example, the data acquired from the first mobile device comprises a reference to a period of parking time for which a user has paid. In this example, the first user has used the first mobile device to pay for one hour of parking time. This data relating to the time which has been paid for is sent to the central server. When the time is within a predetermined period from elapsing, for example, 55 minutes after paying for one hour of parking or has reached a threshold percentage of the paid period (e.g. 90%), the central server may predict that the user is likely to return soon. Hence, a prediction is generated by the central server that the parking space is likely to become vacant within the next five to six minutes.

The or each detection means used by the first mobile device to indicate to the central server that the vehicle of the first user has parked, may also be used by the central server to determine that parking has concluded or will conclude imminently. In one example, the detection means used by the first mobile device was a wireless connection module. In this example, the first mobile device registered a wireless connection status between the wireless connection module and a vehicle driven by the first user. If the wireless connection between the first mobile device and the vehicle registered as “connected” on the first mobile device for a predetermined period of time, and then registered as “disconnected”, this triggered the first mobile device to transmit a notification to the central server regarding the change in connection status.

In such a case, the central server may determine that the disconnection was the result of the first mobile device moving out of range of their vehicle, for example if the first user left their vehicle parked while they walked away with their first mobile device. Therefore, the central server recorded that a parking space has been occupied. However, inversely, the status of the connection between the first mobile device and the vehicle driven by the first user may also be transmitted to the central server resulting in a determination that the user is likely to move their vehicle and thereby vacate the parking space imminently.

In this new example, the wireless connection between the first mobile device and the vehicle registered as “disconnected” on the first mobile device for a predetermined period of time, and then registered as “connected”. This change triggered the first mobile device to transmit a notification to the central server regarding the change in connection status. This notification was received by the central server, which determined that the user had returned to their vehicle, and hence is likely to drive away within a short time period, leaving the parking space vacant.

Alternatively or additionally, the central server records a first location transmitted by the first mobile device, the first location being the location at which data was transmitted to the central server by the first mobile device and the central server determined that the vehicle had parked. Subsequently, the first mobile device transmits a second location to the central server. The central server, on receiving the transmission from the first mobile device, compares the first and second location. If the second location is substantially similar to the first location, then the central server determines that the first user has returned to the site where their vehicle was parked, and hence has completed their errand and the parking space will become vacant imminently.

The central server may use machine learning to predict when a certain motion, at a certain time, indicates a first user is preparing to leave the parking space, optionally using location data from the first mobile device. Such motions may include the detection of a user walking from a cafe, in front of a store, approaching the end of their paid block of time to use the parking space, termination of a phone call, and/or coming into proximity of their parked vehicle. For example, the location of the first mobile device may be received by the central server, and indicate that the first user is leaving a supermarket. This may be interpreted by the machine learning performed by the central server as a signal that their shopping trip is over, and they are ready to return home, leaving their parking space vacant. Alternatively or additionally, the machine learning performed by the central server may incorporate previous user behaviour as an input, such as one or more of: user location habits at different times of the day, and/or the previous spending habits of a user at certain times. Alternatively or additionally, the machine learning performed by the central server may consider group behaviours, such as the time that school starts or ends, when local shops are closed, and/or public holidays.

Alternatively or additionally, the central server may use machine learning to predict when a certain motion, at a certain time, indicates a first user is going to leave a parking space before they have even arrived. If a user has already committed to a block of time ahead of their arrival (for example by paying for one hour of parking), then machine learning may be used as at least part of a prediction as to when the space will become available again once occupied. Prediction of future parking duration may additionally or alternatively be performed based on geolocation, for example a user may be likely to spend longer at a large shopping centre compared to a doctor's office. Each destination may have characteristic average durations of attendance for a user.

It is appreciated that in some embodiments the detection that a user has parked their vehicle is performed by a mobile device, for example by using a parking app on their mobile device. The use of the parking app is detected by the mobile device, and transmitted to the central server. The central server receives the data, and updates the occupancy database accordingly. Alternatively or additionally, only location data is transmitted from the or each mobile device. In such a case, the central server receives the location data and determines using the location data, optionally alongside other data received from the or each mobile device, whether a user has parked their vehicle and/or whether a user is preparing to leave the parking space with their vehicle.

In step 120, data is transmitted to the central server regarding a request for a parking space from a second user, via a second mobile device. Having received the data regarding the request from the second mobile device, the central server determines in step 125 how long the second user will take to arrive at that parking space, based on one or more factors in the data transmitted from the second mobile device to the central server. These factors may include, for example, the level of road traffic present between the location of the second mobile device and the location of the parking space.

In one example, the second mobile device comprises a geolocation module. When the second mobile device transmits a request for a parking space, there is transmitted alongside the request a final destination for the second user, and a current location of the second user. In this example, the central server is operable to locate a parking space within a predetermined distance of the final destination, and determines how long the second user will take to arrive at that parking space based on both the current location and the final destination.

The central server then performs in step 130 a further prediction using the data from the second mobile device as an input. This second prediction is in regard to when the second user will arrive at a particular parking space, and uses at least the determination from step 125 regarding the estimated time of arrival as an input.

Dependent on the first and second predictions, performed at steps 115 and 130 respectively, the central server transmits to the second device data regarding the availability of the parking space. Specifically, if the central server predicts, within a predetermined level of certainty, that the parking space will be available at the point at which the second user is predicted to arrive, then central server will transmit the relevant data to the second mobile device in step 135. Otherwise, the central server will transmit alternative instructions to the second device regarding the use of alternative parking space.

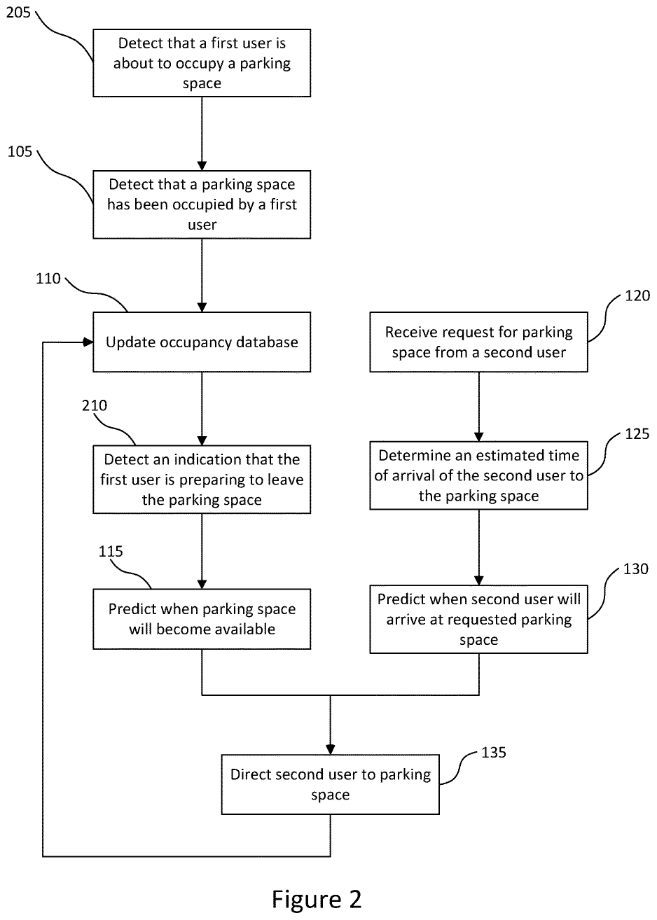

FIG. 2 is a flow diagram of a second example method of detecting and coordinating parking space availability which is a variation on that shown in FIG. 1. In step 205, the first mobile device is used to detect that the first user is going to occupy a parking space. As in relation to the step 105 of detecting that a parking space has been occupied, step 205 may be performed via a geolocation module in the first mobile device.

In such an example, a first user inputs to their first mobile device that they are planning a journey. This data is transmitted to the central server. The central server, in response to receiving this data, predicts how long the first user will take to complete their journey. Using this predicted time period, the central server then predicts at what time the first user is going to arrive at the parking space, and hence at what time the parking space is likely to be occupied.

FIG. 2 also comprises the optional additional feature of detecting in step 210 an indication that the first user is preparing to leave the parking space. In one example, such an indication would include the geolocation of the first mobile device moving at a predetermined speed following a period of inactivity. This may indicate that a user has finished their task, such as shopping, and is walking back to their vehicle. Alternatively or additionally, other location data may be gathered by the first mobile device and transmitted to the central server, which may determine that the location of the first mobile device has changed from being stationary in an area labelled “retail” to moving along an area marked “road”. The central server may then determine that the user is likely to have finished their task, and is returning to their vehicle, and hence the parking space is going to become vacant soon after the user has arrived back at their vehicle.

Data regarding the geolocation of the first mobile device is captured by the first mobile device itself, and transmitted to the central server. Once the data has been transmitted to the central server, the central server analyses the data to provide a refined input to the subsequent prediction in step 115 regarding when the parking space will become available, thereby producing a more accurate prediction.

If the central server predicted, within a predetermined level of certainty, that the parking space was available at the point at which the second user was predicted to arrive, and the relevant data was transmitted to the second mobile device in step 135, then the occupancy database of step 110 is updated. In such a case, the second user takes the nomenclature of “first user”, and the second mobile device takes the nomenclature of “first mobile device”, and the process may loop again.

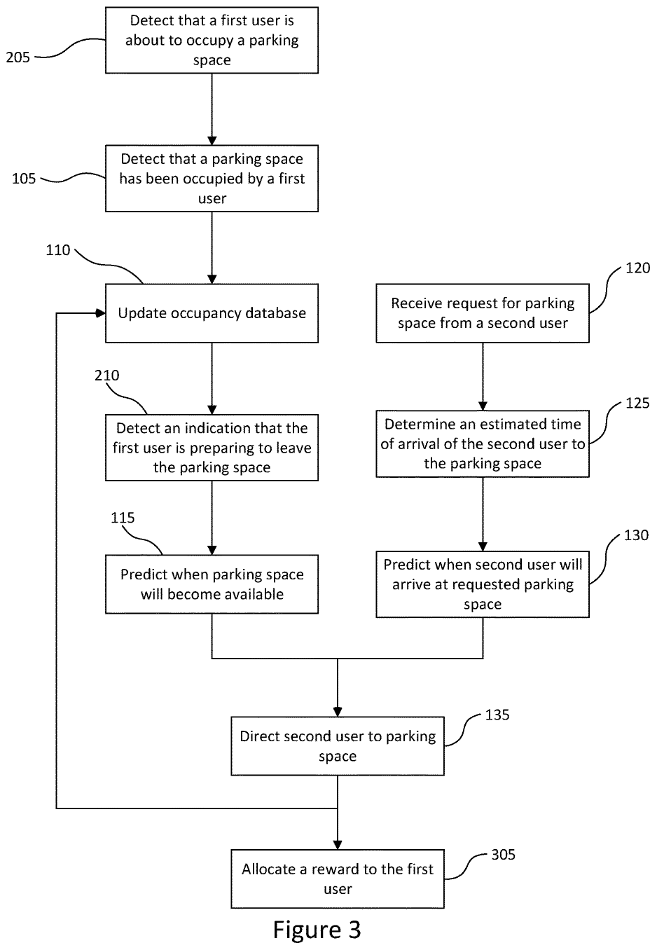

In some embodiments, the first mobile device and second mobile device have a common digital application, also referred to as an app, downloaded locally to their respective memories. The app collates any required sensor data acquired from the first or second mobile devices, and is in electronic communication with the central server. In such cases, the first user may be “rewarded” in step 305 of FIG. 3 for a successful handover of a parking space to the second user. FIG. 3 is a flow diagram of a third example method of detecting and coordinating parking space availability which is a variation on that shown in FIGS. 1 and 2. Such a reward may take the form of bonus content within the app, a relevant voucher code for a discount to the same or another service, priority for other parking spaces, and/or other financial incentive. Alternatively or additionally, the reward may include the allocation of: points, stickers, kudos, and/or unlockable characters.

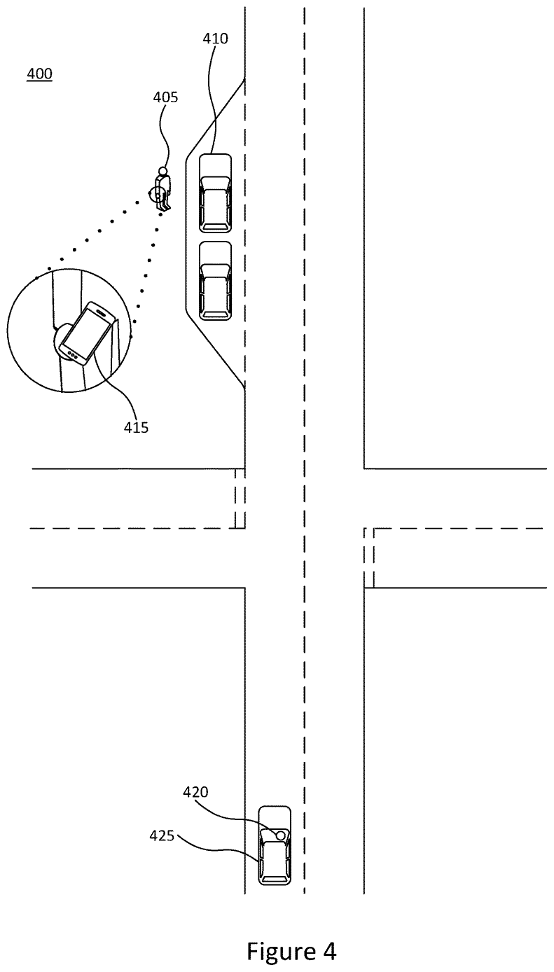

FIG. 4 shows an example of the method as previously described from the point of view of a user. There is shown a plan view 400 comprising two users 405 and 420, each of whom is carrying a mobile device (optionally a smartphone) in electronic communication with a remote central server. In this example scenario, the first user 405 has parked his vehicle 410 next to a road, and is equipped with a first mobile device 415. It is appreciated that this method is equally applicable in a car park or any other vehicle storage location.

The first user 405 is carrying a mobile device, such as a smartphone 415, equipped with one or more sensor modules. The smartphone 415 is operable to detect that the first user 405 has parked in a specific parking space, for example by detecting that the user 405 has started moving at a walking pace, rather than at a driving pace, indicating that they are no longer inside a vehicle. Alternatively or additionally, the smartphone 415 detects that the wireless pairing between the smartphone 415 and the vehicle 410, such as a Bluetooth connection, has ended. The user may have actively unpaired their smartphone 415 as they intend to leave their vehicle 410 imminently. The pairing may also have ended if the smartphone 415 was moved out of range of the vehicle 410, for example if the first user 405 left their vehicle 410 parked while they walked away with their smartphone 415, or if a Bluetooth module of the vehicle 410 was automatically deactivated when the vehicle 410 was turned off.

Alternatively or additionally, the smartphone 415 may have installed locally an app for the purpose of paying for parking within specific zones of a city environment. In one example, the smartphone 415 transmits a notification to the central server when the app is accessed by the first user 405. The detection of the use of the parking app by the first user 405 may indicate that the user is intending to park within a specific parking space or zone. Data from the parking app may further indicate the length of time for which the user 405 intends to park, for example by including a payment covering a specific amount of time for which the user intends to park.

On completing their reason for parking, for example completing a chore that required the use of the vehicle 410, the first user 405 may be considered by the central server likely to return to their vehicle 410. The or each sensor on the smartphone 415 may be used to detect that parking has terminated, or that parking will terminate imminently.

In one example, the first user 405 used a parking app on their smartphone 515 to pay for the use of the parking space over a predetermined period. The relevant data was transmitted to the central server, including data regarding the period of time for which parking has been paid. When the parking period is nearly over, for example within five minutes of terminating, the central server determines that the probability of the vehicle 410 remaining in the space decreases. If the first user 405 has not moved their vehicle 410 at the moment their prepaid time is up, they risk receiving a fine as punishment. This arrangement is designed to motivate users to move their vehicle before the end of the parking time that they have paid for.

Alternatively or additionally, the smartphone 415 detects that the first user 405 has moved location, and is travelling towards their vehicle 410. This may be interpreted by the smartphone 415 that the user is returning to their vehicle 410 in order to leave the parking space. This data is transmitted to the central server, and used as part of an input to predict that the parking space will be vacant, and so free for another user, within a predetermined amount of time.

The central server, when predicting when the first user 405 will move their vehicle 410 and so vacate their parking space, may include as an input one or more factors relating to that first user 405 specifically. For example, the central server may utilize collected data stating that the first user 405 has an average walking speed of 5 km/h. Therefore, if the central server predicts that the user 405 has finished their errand, and is leaving a store 1 km away from the parking space, they will return in approximately 12 minutes.

Alternatively or additionally, the smartphone 415 detects that the wireless pairing between the smartphone 415 and the vehicle 410, such as a Bluetooth connection, has resumed. A Bluetooth pairing requires a level of proximity between the smartphone 415 and the vehicle 410 which indicates that the user 405 is local to their vehicle. In such a case, it is likely that the user 405 has returned to their vehicle 410 and hence will be vacating the parking space within a short period of time.

In this example, the central server has predicted, within a predetermined level of certainty, that the parking space currently occupied by the vehicle 410 will be available at the point at which the second user 420 is predicted to arrive. Hence, the central server transmits to the second mobile device an instruction regarding the location and vacant status of the parking space. The second user 420 is then directed to the parking space using the second mobile device, enabling them to park with improved convenience. This also helps reduce fuel wastage while circling around the roads looking for space to park, making the journey of the second user 420 more efficient.

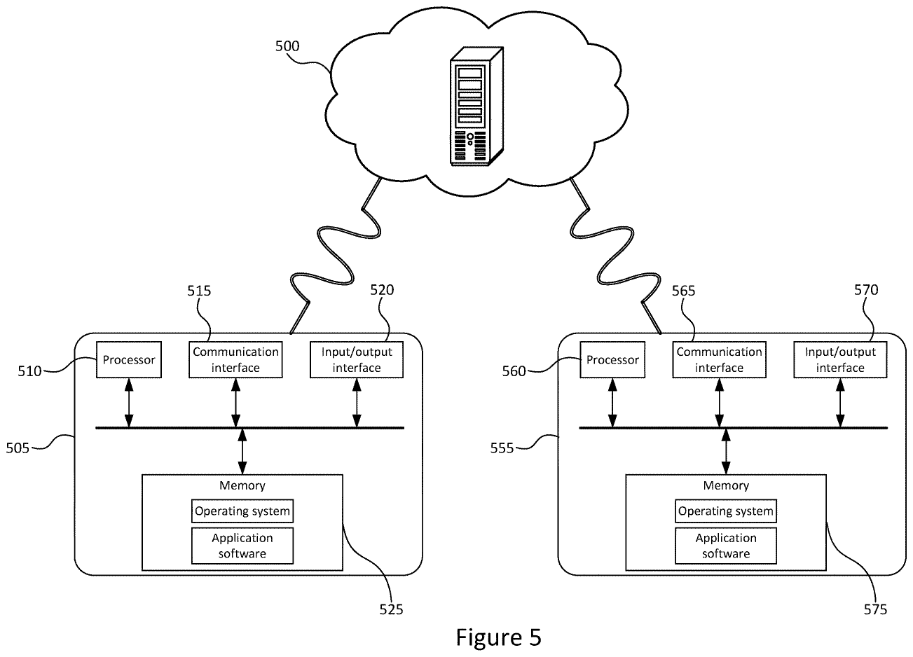

FIG. 5 is a representation of the links between different computer entities. In this figure, there is shown a central server 500. The central server 500 is operable to perform all of the steps of any of the methods disclosed herein.

In at least some embodiments, the central server 500 is in electronic communication with one or more mobile devices 505, 510, optionally in the form of smartphones. The first mobile device 505 comprises a processor 510, a communication interface 515, and an input/output interface 520. The input/output interface 520 further comprises a display and a user input device (not shown). In the case of a touchscreen smartphone, the display and user input device may be one in the same.

The first mobile device 505 also comprises a memory 525, itself comprising an operating system and application software. The application software may include parking-specific software in the form of an app.

The second mobile device 555 also comprises a processor 560, a communication interface 565, and an input/output interface 570. The input/output interface 570 further comprises a display and a user input device (not shown). In the case of a touchscreen smartphone, the display and user input device may be one in the same.

The second mobile device 555 also comprises a memory 575, itself comprising an operating system and application software. The application software may include parking-specific software in the form of an app.

The or each mobile device 505, 510 is in electronic communication with the central server 500. The or each mobile device 505, 510 comprises one or more sensors, operable to collect data relevant to the one or more method steps performed by the central server 500. This data is then transmitted to the central server 500, and used in the performance of one or more of the predictions performed by the central server 500.

The or each computing-based device of this figure comprises one or more processors which may be microprocessors, controllers or any other suitable type of processors for processing computer executable instructions to control the operation of the device. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The computer executable instructions may be provided using any computer-readable media that is accessible by any computing based device. Computer-readable media may include, for example, computer storage media such as memory and communications media. Computer storage media, such as memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory) is shown within the computing-based devices it will be appreciated that the storage may be distributed or located remotely and accessed via a network or other communication link (e.g. using a communication interface).

Each computing-based device can also comprise an input/output controller arranged to output display information to a display device which may be separate from or integral to the computing-based device. The display information may provide a graphical user interface. The input/output controller is also arranged to receive and process input from one or more devices, such as a user input device (e.g. a mouse or a keyboard). This user input may be used to provide information required into the computing environment. In an embodiment the display device may also act as the user input device if it is a touch sensitive display device. The input/output controller may also output data to devices other than the display device, e.g. a locally connected printing device.

The term computer is used herein to refer to any device with processing capability such that it can execute instructions. Those skilled in the art will realize that such processing capabilities are incorporated into many different devices and therefore the term computer includes PCs, servers, mobile telephones, personal digital assistants, and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A computer-implemented method of identifying an available parking space, comprising:
detecting that a parking space has been occupied by a first user;
updating an occupancy database that the parking space has been occupied;
performing a first prediction regarding when the parking space will become available from the first user;
receiving an indication that a second user is seeking a parking space;
performing a second prediction regarding when the second user will arrive at the parking space; and
dependent on the first prediction and the second prediction, directing the second user to the parking space.

2. The method of claim 1, wherein the performing of the first prediction comprises the use of historical data.

3. The method of claim 1, wherein the performing of the first prediction comprises the detection of motion of a mobile device of the first user.

4. The method of claim 1, wherein the performing of the first prediction comprises the detection of a data connection between a mobile device of the first user and a vehicle of the first user.

5. The method of claim 1, wherein the performing of the first prediction comprises the detection of a payment transaction on a mobile device of the first user.

6. The method of claim 1, wherein the updating of the occupancy database is performed wirelessly.

7. The method of claim 1, wherein the first prediction and/or second prediction is performed using machine learning.

8. The method of claim 1, wherein the performing of the second prediction comprises the use of navigational data.

9. A system for identifying an available parking space, comprising:
a central server, operable to:
detect that a parking space has been occupied by a first user via a first mobile device;
update an occupancy database that the parking space has been occupied;
perform a first prediction regarding when the parking space will become available from the first user;
receive an indication that a second user is seeking a parking space from a second mobile device;
perform a second prediction regarding when the second user will arrive at the parking space; and
dependent on the first prediction and the second prediction, direct the second user to the parking space.

10. The system of claim 9, wherein the central server comprises one or more machine learning modules.

11. The system of claim 9, wherein the detection via the first mobile device comprises the use of a local mobile app.

12. The system of claim 9, wherein the indication via the second mobile device comprises the use of a local mobile app.

13. The system of claim 9, wherein the central server is further operable to:
push a notification to the first mobile device when the parking space has been occupied by the second user.

14. A non-transitory, computer readable media comprising machine-executable instructions which, when executed on a device, cause the device to perform acts comprising:
detecting that a parking space has been occupied by a first user;
updating an occupancy database that the parking space has been occupied;
performing a first prediction regarding when the parking space will become available from the first user;
receiving an indication that a second user is seeking a parking space;
performing a second prediction regarding when the second user will arrive at the parking space; and
dependent on the first prediction and the second prediction, directing the second user to the parking space.
